(19) United States
(12) Patent Application Publication
(10) Pub. No.: US 2010/0013180 A1
(43) Pub. Date: Jan. 21, 2010

(54) THREE-WHEELED VEHICLE WITH REAR AXLE CONTROL LINK

(75) Inventors: Conrad Scott Allman, JR., North Prairie, WI (US); Tyler Kulig, New Berlin, WI (US); Thomas Wolcott, Queen Creek, AZ (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 12/173,948

(22) Filed: Jul. 16, 2008

(51) Int. Cl. B62D 61/06

(52) U.S. Cl. 280/62

(57) ABSTRACT

A three-wheeled vehicle includes a frame including a longitudinal axis and a steering head, an engine-transmission assembly coupled to the frame, a steering assembly pivotably coupled to the steering head, a front wheel rotatably coupled to the steering assembly, a rear axle assembly, a control arm coupling the rear axle assembly to the frame, a pair of rear wheels rotatably supported by the rear axle assembly, and a substantially laterally-extending link interconnecting the rear axle assembly and the frame to control lateral motion of the rear axle assembly relative to the frame.

### FIELD OF THE INVENTION

The present invention relates to vehicles, and more particularly to suspension systems for three-wheeled vehicles.

### BACKGROUND OF THE INVENTION

Three-wheeled motorcycles or “trikes” are commonly manufactured using a motorcycle frame as its foundation. Usually, a conventional or slightly modified motorcycle frame is used in combination with a rear frame, which is typically mounted to a rear portion of the conventional motorcycle frame. A rear axle assembly may be solidly or rigidly mounted to the rear frame, or the rear axle assembly may be pivotably mounted to the conventional motorcycle frame via a swing arm or one or more control arms to allow the rear axle assembly to pivot about an axis substantially normal to a longitudinal axis of the conventional motorcycle frame.

### SUMMARY OF THE INVENTION

The present invention provides, in one aspect, a three-wheeled vehicle including a frame including a longitudinal axis and a steering head, an engine-transmission assembly coupled to the frame, a steering assembly pivotably coupled to the steering head, a front wheel rotatably coupled to the steering assembly, a rear axle assembly, a control arm coupling the rear axle assembly to the frame, a pair of rear wheels rotatably supported by the rear axle assembly, and a substantially laterally-extending link interconnecting the rear axle assembly and the frame to control lateral motion of the rear axle assembly relative to the frame.

The present invention provides, in another aspect, a three-wheeled vehicle including a frame including a longitudinal axis and a steering head, an engine-transmission assembly coupled to the frame, a steering assembly pivotably coupled to the steering head, a front wheel rotatably coupled to the steering assembly, a rear axle assembly defining a longitudinal axis, a pair of rear wheels rotatably supported by the rear axle assembly, and a link interconnecting the rear axle assembly and the frame to control lateral motion of the rear axle assembly relative to the frame. The link is pivotable relative to the rear axle assembly about an axis oriented substantially normal to the longitudinal axis of the rear axle assembly.

Other features and aspects of the invention will become apparent by consideration of the following detailed description and accompanying drawings.

### BRIEF DESCRIPTION OF THE DRAWINGS

FIG. 1 is a side view of a three-wheeled vehicle embodying the present invention.

FIG. 2 is an exploded, rear perspective view of a portion of the three-wheeled vehicle of FIG. 1.

FIG. 3 is an assembled, rear perspective view of the portion of the three-wheeled vehicle shown in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

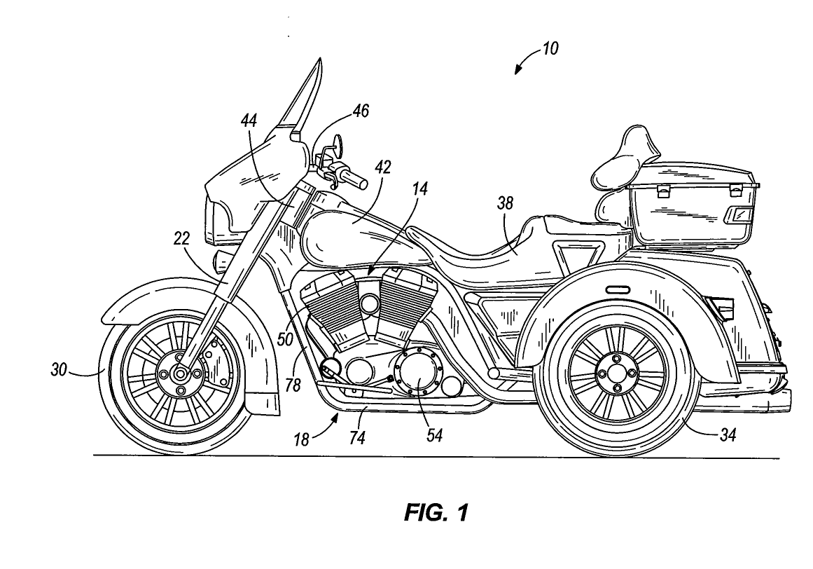

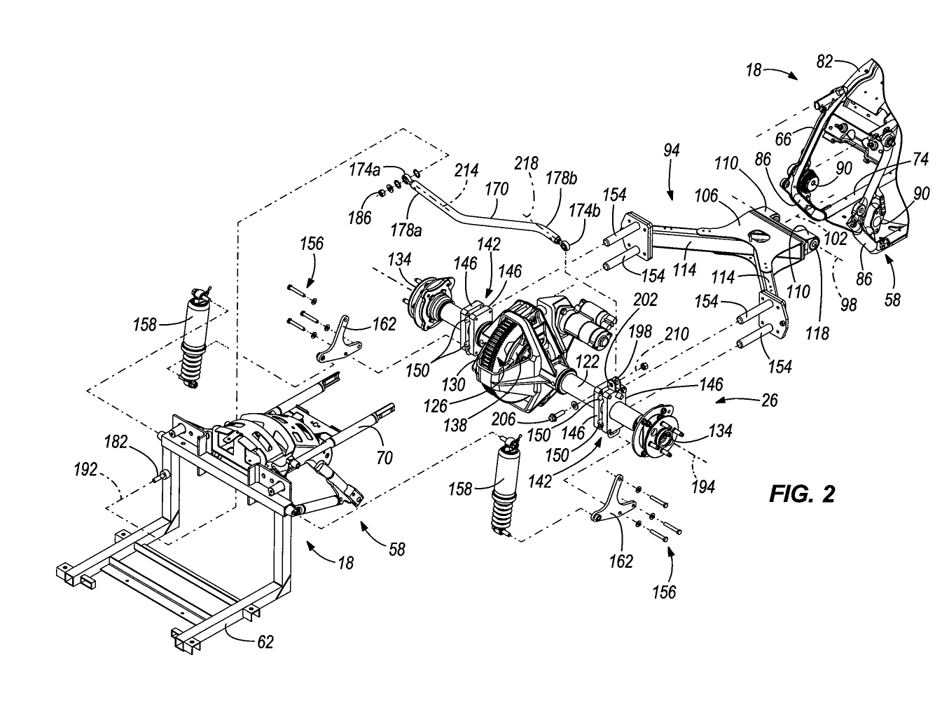

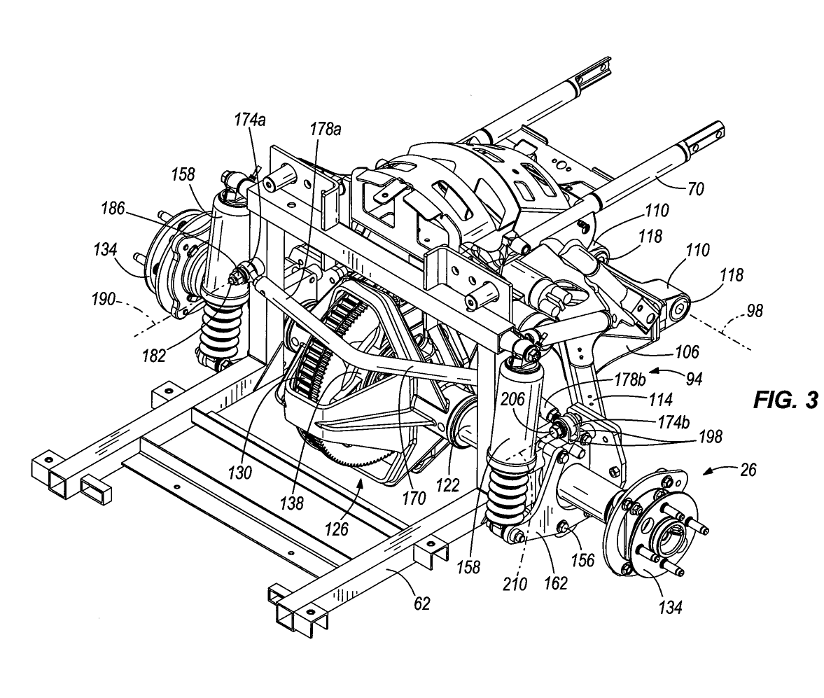

FIG. 1 illustrates a three-wheeled vehicle or motorcycle 10, commonly known to those skilled in the art as a “trike,” including an engine-transmission assembly 14, a multi-piece frame 18, a front fork assembly 22, a rear axle assembly 26 (see FIGS. 2 and 3), a front wheel 30, a pair of rear wheels 34 (only one of which is shown in FIG. 1), a seat 38, and a fuel tank 42. The frame 18 supports the engine-transmission assembly 14, the front fork assembly 22, the seat 38, and the fuel tank 42. The frame 18 includes a steering head 44 that pivotally supports the front fork assembly 22, which, in turn, supports the front wheel 30. The front fork assembly 22 includes a pair of handlebars 46 for steering the vehicle 10. The rear axle assembly 26 is coupled to the frame 18 at a rear end of the vehicle 10 and rotatably supports the rear wheels 34. The seat 38 is coupled to the frame 18 and is configured for supporting a rider. The fuel tank 42 is supported by the frame 18 and provides fuel to the drive assembly 14.

The engine-transmission assembly 14 is coupled to the frame 18 beneath the seat 38 between the front wheel 30 and the rear wheels 34 of the vehicle 10. With continued reference to FIG. 1, the engine-transmission assembly 14 includes an engine 50 and a transmission 54, which comprise distinct, independent components of the assembly 14. The engine 50 comprises a V-twin engine 50 supported by the frame 18 forward of the transmission 54. The engine 50 includes an output shaft (not shown), such as a crankshaft, which includes a primary drive sprocket (not shown) for driving a primary chain (not shown) in a conventional manner to power the transmission 54.

With reference to FIG. 2, the multi-piece frame 18 includes a main frame assembly 58 and a rear frame 62 coupled to the main frame assembly 58. In the illustrated construction of the three-wheeled vehicle 10, the main frame assembly 58 includes a first or a main frame 66 and a second or a tail frame 70 fastened to the main frame 66. Alternatively, the main frame assembly 58 may be configured as a unitary structure, or, as a further alternative, the main frame 66, tail frame 70, and rear frame 62 may be configured as a unitary structure. With continued reference to FIGS. 1 and 2, the main frame 66 includes the steering head 44, a pair of substantially longitudinal frame members 74 configured to support the engine-transmission assembly 14, a pair of down-tubes 78 extending between the steering head 44 and the longitudinal frame members 74, and a frame backbone 82. The main frame 66 also includes a pair of rear frame members 86 extending between the longitudinal frame members 74 and the frame backbone 82. In the illustrated construction of the three-wheeled vehicle 10, the rear frame members 86 are forgings that are welded to the longitudinal frame members 74 and other portions of the frame 66 (e.g., the frame backbone 82). The rear frame members 86 also each include a pivot 90 configured to receive a pin or an axle (not shown) for pivotably mounting the rear axle assembly 26. Alternatively, the rear frame members 86 may be made from any appropriate process such as a casting process, or the rear frame members 86 may comprise a rear portion of the main frame 66 that does not support the rear axle assembly 26. As a further alternative, the main frame 66 may have any of a number of different configurations.

With reference to FIG. 2, the three-wheeled vehicle 10 also includes a swing arm or control arm 94 pivotably coupling the rear axle assembly 26 to the main frame 66 about a pivot axis 98 oriented substantially horizontal, which is normal to a longitudinal axis 102 of the multi-piece frame 18. In the illustrated construction of the three-wheeled vehicle 10, the control arm 94 includes a mounting portion 106 having dual bushing supports 110, and dual arm portions 114 coupled to and extending from the mounting portion 106 at an oblique angle relative to the longitudinal axis 102. Any of a number of different processes (e.g., welding, fastening, etc.) may be utilized to couple the mounting portion 106 and the arm portions 114. Alternatively, the control arm 94 may be configured as a unitary structure.

With continued reference to FIG. 2, a bushing 118 is positioned within each of the bushing supports 110 on the control arm 94. A pin or axle (not shown) is received within the respective bushings 118, and the pivot 90 may include additional bushings or bearings configured to receive opposite ends of the axle to pivotably support the control arm 94 relative to the main frame 66.

With reference to FIGS. 2 and 3, the rear axle assembly 26 includes a housing 122, a differential assembly 126 rotatably supported within the housing 122, a sprocket 130 coupled to the differential assembly 126, and dual axles 134 coupled to the differential assembly 126 and supported for rotation relative to the housing 122. The differential assembly 126 includes a carrier 138 to which the sprocket 130 is coupled (e.g., with fasteners, etc.) and a plurality of gears (not shown) positioned within the carrier 138. An endless drive member (e.g., a belt, etc.; not shown) is utilized to transfer torque from an output shaft of the transmission 54 to the sprocket 130. The torque input applied to the differential assembly 126 via the sprocket 130 is divided by the differential assembly 126 between the two axles 134. In addition, the differential assembly 126 is operable to allow relative rotation between the axles 134 while turning the three-wheeled vehicle 10, as is generally known in the field of differentials.

With reference to FIG. 2, the arm portions 114 of the control arm 94 are coupled to the housing 122 by respective bracket assemblies 142. In the illustrated construction of the three-wheeled vehicle 10, each of the bracket assemblies 142 includes a pair of opposed plates 146, each having spaced grooves or recesses 150 configured to receive therebetween respective cylindrical projections 154 extending from the distal end of each arm portion 114. Specifically, the cylindrical projections 154 are clamped between the respective plates 146, which are secured to each other by a plurality of fasteners 156 (e.g., bolts, etc.), to secure the control arm 94 to the housing 122. Alternatively, the bracket assemblies 142 may be differently configured to secure the control arm 94 to the housing, or as a further alternative, any of a number of different structures may be utilized to secure the control arm 94 to the housing 122.

With continued reference to FIG. 2, the three-wheeled vehicle 10 includes a pair of struts 158 coupling the frame 18 and the rear axle assembly 26 to control the movement of the rear axle assembly 26 relative to the frame 18 during operation of the three-wheeled vehicle 10. In the illustrated construction of the three-wheeled vehicle 10, an upper end of each of the struts 158 is mounted to the rear frame 62, and a lower end of each of the struts 158 is mounted to a bracket 162 which, in turn, is mounted to the axle housing 122 by the fasteners 156. Alternatively, the brackets 162 may be integrally formed as a single piece with one of the plates 146 in the respective bracket assemblies 142. As a further alternative, separate springs and shocks may be utilized by the vehicle 10 rather than the illustrated struts 158.

With reference to FIGS. 2 and 3, the three-wheeled vehicle 10 also includes a stabilizing or control link 170 interconnecting the frame 18 and the rear axle assembly 26 to provide lateral stability to the rear axle assembly 26 relative to the frame 18. In other words, the link 170 is operable to inhibit lateral motion of the rear axle assembly 26 relative to the frame 18 during upward and downward pivoting movement of the rear axle assembly 26 as provided by the control arm 94 and the struts 158. Lateral movement of the rear axle assembly 26 with respect to the frame 18 is limited to the lateral or side-to-side component of the arcuate path traversed by the rear axle assembly 26 between the upward and downward extents of suspension travel, as determined by the length of the link 170.

With reference to FIG. 2, spherical joints 174a, 174b (e.g., spherical rod ends) are coupled to respective ends 178a, 178b of the link 170. In the illustrated construction of the three-wheeled vehicle 10, the rear frame 62 includes a cylindrical mount 182, upon which the spherical joint 174a of the link 170 is rotatably supported, extending from the rear frame 62 in a direction substantially parallel with the longitudinal axis 102. The cylindrical mount 182 includes a threaded end to which a fastener (e.g., a nut 186) is threaded to secure the spherical joint 174a of the link 170 to the rear frame 62 (see FIG. 3). When assembled in this manner, the link 170 is pivotable relative to the rear frame 62 about a pivot axis 190 extending in a direction substantially normal to the pivot axis 98 of the control arm 94. The pivot axis 190 is also oriented substantially normal to a longitudinal axis 194 of the rear axle assembly 26, which is defined by the rotational axis of the axles 134. Alternatively, the spherical joint 174a may be pivotably coupled to the rear frame 62 in any of a number of different ways and using any of a number of different structures.

With reference to FIG. 2, one of the plates 146 of one of the bracket assemblies 142 includes a pair of substantially parallel, spaced tabs 198 between which the spherical joint 174b of the link 170 is rotatably supported. Specifically, the tabs 198 include respective aligned apertures 202 through which a fastener (e.g., a bolt 206) is inserted to rotatably support the spherical joint 174b on the tabs 198. The aligned apertures 202 define another pivot axis 210, extending in a direction substantially normal to the pivot axis 98 of the control arm 94, about which the link 170 may pivot relative to the axle housing 122. The pivot axis 210 is also oriented substantially normal to the longitudinal axis 194 of the rear axle assembly 26. Alternatively, the spherical joint 174b may be pivotably coupled to the axle housing 122 in any of a number of different ways and using any of a number of different structures.

With continued reference FIG. 2, the respective ends 178a, 178b of the link 170 are offset from each other. More particularly, the end 178a of the link 170 defines a central axis 214 (perpendicular to the central rotational axis of the spherical joint 174a) that is offset in a direction substantially parallel with the longitudinal axis 102 of the frame 18, relative to a central axis 218 defined by the end 178b of the link 170 (perpendicular to the central rotational axis of the spherical joint 174b). In other words, the axes 214, 218 are substantially parallel to each other and are offset from one another by a distance along the longitudinal axis 102. Alternatively, the link 170 may be configured to be substantially straight, or as a further alternative, the link 170 may be configured with any of a number of different shapes.

In operation of the three-wheeled vehicle 10, the rear axle assembly 26 is pivotable relative to the frame 18 about the pivot axis 98. The struts 158, in a conventional manner, control acceleration and speed of the movement of the rear axle assembly 26 relative to the frame 18. With reference to FIG. 2, the link 170 is pivotable relative to the frame 18 about the pivot axis 190, and pivotable relative to the rear axle assembly 26 about the pivot axis 210, during upward and downward movement of the rear axle assembly 26 and control arm 94 about the pivot axis 98. The rear axle assembly 26, therefore, is substantially laterally constrained relative to the frame 18 throughout the full range of travel of the rear axle assembly 26 permitted by the struts 158. As a result, the alignment of the sprocket 130 relative to a drive gear (not shown) coupled to the output shaft of the transmission 54 is substantially maintained. Without the link 170 to laterally constrain the rear axle assembly 26 relative to the frame 18, side-by-side or lateral movement of the rear axle assembly 26 might cause misalignment between the sprocket 130 and the drive gear on the output shaft of the transmission 54 which, in turn, might cause the endless drive member to impart a bending or side load on the output shaft of the transmission 54. By incorporating the link 170 with the vehicle 10, bending or side-loading of the output shaft of the transmission 54 due to the endless drive member stretching to accommodate any misalignment between the sprocket 130 and the drive gear is substantially reduced. Further, strain imparted to the housing of the transmission 54 as a result of such bending or side-loading of the output shaft of the transmission 54 is reduced.

Various features of the invention are set forth in the following claims.

What is claimed is:

1. A three-wheeled vehicle comprising:
a frame including a longitudinal axis and a steering head;
an engine-transmission assembly coupled to the frame;
a steering assembly pivotably coupled to the steering head;
a front wheel rotatably coupled to the steering assembly;
a rear axle assembly;
a control arm coupling the rear axle assembly to the frame;
a pair of rear wheels rotatably supported by the rear axle assembly; and
a substantially laterally-extending link interconnecting the rear axle assembly and the frame to control lateral motion of the rear axle assembly relative to the frame.

2. The three-wheeled vehicle of claim 1, wherein the link is pivotably coupled to the frame at a first end of the link, and wherein the link is pivotably coupled to the rear axle assembly at a second end of the link.

3. The three-wheeled vehicle of claim 1, wherein the rear axle assembly is pivotable relative to the frame about a first axis, and wherein the link is pivotable relative to the rear axle assembly about a second axis oriented substantially normal to the first axis.

4. The three-wheeled vehicle of claim 3, wherein the link is pivotable relative to the frame about a third axis oriented substantially parallel with the second axis and substantially normal to the first axis.

5. The three-wheeled vehicle of claim 1, further comprising:
a first spherical joint pivotably coupling a first end of the link and the frame; and
a second spherical joint pivotably coupling a second end of the link and the rear axle assembly.

6. The three-wheeled vehicle of claim 1, wherein a first end of the link defines a first central axis, and wherein a second end of the link defines a second central axis offset from the first central axis.

7. The three-wheeled vehicle of claim 1, wherein the rear axle assembly includes a rear axle housing, and wherein the link is pivotably coupled to the rear axle housing.

8. A three-wheeled vehicle comprising:
a frame including a longitudinal axis and a steering head;
an engine-transmission assembly coupled to the frame;
a steering assembly pivotably coupled to the steering head;
a front wheel rotatably coupled to the steering assembly;
a rear axle assembly defining a longitudinal axis;
a pair of rear wheels rotatably supported by the rear axle assembly; and
a link interconnecting the rear axle assembly and the frame to control lateral motion of the rear axle assembly relative to the frame, wherein the link is pivotable relative to the rear axle assembly about an axis oriented substantially normal to the longitudinal axis of the rear axle assembly.

9. The three-wheeled vehicle of claim 8, wherein the link is pivotably coupled to the frame at a first end of the link, and wherein the link is pivotably coupled to the rear axle assembly at a second end of the link.

10. The three-wheeled vehicle of claim 8, further comprising a control arm coupling the rear axle assembly to the frame, wherein the control arm is pivotable relative to the frame about an axis oriented substantially parallel with the longitudinal axis of the rear axle assembly.

11. The three-wheeled vehicle of claim 8, further comprising:
a first spherical joint pivotably coupling a first end of the link and the frame; and
a second spherical joint pivotably coupling a second end of the link and the rear axle assembly.

12. The three-wheeled vehicle of claim 8, wherein a first end of the link defines a first central axis, and wherein a second end of the link defines a second central axis non-collinear with the first central axis.

13. The three-wheeled vehicle of claim 8, wherein the rear axle assembly includes a rear axle housing, and wherein the link is pivotably coupled to the rear axle housing.
